(19) United States
(12) Patent Application Publication
(10) Pub. No.: US 2014/0136531 A1
(43) Pub. Date: May 15, 2014

(54) Managing Delivery of Contextual Content

(71) Applicants: Ben Aflalo, Raanana (IL); Vitaly Vainer, Kfar Saba (IL); Guy Bavly, Herzilia (IL); Avi Guzansky, Raanana (IL); Yahali Sherman, Tel Aviv (IL); Pavel Kravets, Petach Tikva (IL); Itay Sagiv, Hadera (IL); Ohad Schachtel, Tel Aviv (IL); Gili Boker, Netanya (IL)

(72) Inventors: Ben Aflalo, Raanana (IL); Vitaly Vainer, Kfar Saba (IL); Guy Bavly, Herzilia (IL); Avi Guzansky, Raanana (IL); Yahali Sherman, Tel Aviv (IL); Pavel Kravets, Petach Tikva (IL); Itay Sagiv, Hadera (IL); Ohad Schachtel, Tel Aviv (IL); Gili Boker, Netanya (IL)

(21) Appl. No.: 13/674,665

(22) Filed: Nov. 12, 2012

(51) Int. Cl. G06F 17/30

(52) U.S. Cl. 707/728; 707/E17.014

(57) ABSTRACT

Techniques for managing an enterprise portal workspace include identifying user context data in the enterprise portal workspace; querying, based on the user context data, a semantic network including nodes and edges, identifying at least a subset of the plurality of content items based on a match of the user context data and the metadata attributes of the plurality of content items; ranking the identified subset of the plurality of content items based on the match of the user context data and the metadata attributes of the plurality of content items; and preparing the ranked subset of the plurality of content items to display to the user in a virtual workspace of the enterprise portal workspace.

### TECHNICAL BACKGROUND

This disclosure relates to managing delivery of contextually-relevant content of business and other data for a business enterprise.

### BACKGROUND

Business users of software in a business enterprise may utilize a virtual workspace in an enterprise portal to browse, view, modify, and/or otherwise manipulate data related to the business enterprise. Such data may include a variety of information in many different forms, such as sales data, revenue data, human resources information, business hierarchy information, and otherwise. Graphs, tables, charts, electronic communications, web services, reports, and other forms of data, may be viewable in the user's workspace. The workspace may allow or facilitate the resolution of business issues and/or problems by the user. In some situations, however, the workspace itself has no semantic knowledge of the content being viewed and/or manipulated by the user. Thus, the workspace may not able to provide services to the user that rely on a semantic context of data (active or passive) in the workspace, e.g., one or more workspace modules that are on viewable and/or modifiable on the workspace at a given moment. Contextual information, however, may enable the user to identify relationships between existing modules active in the workspace, relationships between active modules and additional data related to the business enterprise, and, generally, enrich the workspace context in the portal.

Further, an enterprise portal may include or act as a content aggregation point in order to deliver the right content at the right context to users. Such delivery is often hampered by several obstacles, such as, for example, very high content volume (e.g., “big data” that is largely unmanageable with traditional database management tools), which is always increasing. Another obstacle includes high variety of content in the data, since data can be structured application data, semi-structured web data, unstructured documents, and other forms of data. Further, big data often has a high velocity of change in the content of the data.

### SUMMARY

General implementations for managing an enterprise portal workspace include identifying user context data in the enterprise portal workspace; querying, based on the user context data, a semantic network including nodes and edges, identifying at least a subset of the plurality of content items based on a match of the user context data and the metadata attributes of the plurality of content items; ranking the identified subset of the plurality of content items based on the match of the user context data and the metadata attributes of the plurality of content items; and preparing the ranked subset of the plurality of content items to display to the user in a virtual workspace of the enterprise portal workspace.

In a first aspect combinable with any of the general implementations, the nodes including metadata attributes of a plurality of content items.

A second aspect combinable with any of the previous aspects further includes identifying the plurality of content items from a data repository.

A third aspect combinable with any of the previous aspects further includes parsing the identified plurality of content items for the metadata attributes;.

A fourth aspect combinable with any of the previous aspects further includes storing the parsed metadata attributes in nodes of the semantic network.

In a fifth aspect combinable with any of the previous aspects further includes, the data repository includes an in-memory database that is communicably coupled to an enterprise computing system.

In a sixth aspect combinable with any of the previous aspects, each content item of the ranked subset includes a primary content item.

A seventh aspect combinable with any of the previous aspects further includes locating each primary content item in a unique sub-area of the virtual workspace displayed to the user through the enterprise portal workspace.

An eighth aspect combinable with any of the previous aspects further includes displaying each primary content item at or near a center of a corresponding sub-area of the virtual workspace.

A ninth aspect combinable with any of the previous aspects further includes performing a sub-query of the semantic network to match the metadata attributes of the primary content items with metadata attributes of other content items of the plurality of content items.

A tenth aspect combinable with any of the previous aspects further includes identifying another subset of the plurality of content items based on the match of metadata attributes of the primary content items with metadata attributes of other content items of the plurality of content items.

An eleventh aspect combinable with any of the previous aspects further includes ranking the identified other subset of the plurality of content items based on the match of metadata attributes of the primary content items with metadata attributes of other content items of the plurality of content items.

In a twelfth aspect combinable with any of the previous aspects further, each content item of the ranked other subset includes a secondary content item.

A thirteenth aspect combinable with any of the previous aspects further includes associating each secondary content item with one of the primary content items based on the match of metadata attributes with the primary content item.

A fourteenth aspect combinable with any of the previous aspects further includes displaying each secondary content item near the associated primary content item in the virtual workspace.

A fifteenth aspect combinable with any of the previous aspects further includes receiving, from the user, a selection of one or more of the ranked plurality of content items.

A sixteenth aspect combinable with any of the previous aspects further includes maintaining the selected content items or a reference to the selected content items viewable in a portion of the virtual workspace.

A seventeenth aspect combinable with any of the previous aspects further includes associating the identified user context data with the selected content items;.

An eighteenth aspect combinable with any of the previous aspects further includes storing the associated identified user context data.

A nineteenth aspect combinable with any of the previous aspects further includes receiving, subsequent to storing the user context data, a request from the user to view the stored user context data associated with the selected content items.

In a twentieth aspect combinable with any of the previous aspects, the user context data includes one or more of user profile data, user provided data, or enterprise content.

In a twenty-first aspect combinable with any of the previous aspects, the user profile data includes one or more of a role in a business enterprise, a position in a business enterprise, a role in a social enterprise, a member of a social group, or a user location.

In a twenty-second aspect combinable with any of the previous aspects, the user provided data includes one or more of business goals, business events, or social events.

In a twenty-third aspect combinable with any of the previous aspects, the enterprise content includes one or more of business data, business objects, web content, or social media content.

A twenty-fourth aspect combinable with any of the previous aspects further includes determining a relevance indicator for one or more content items based, at least in part, on interaction between other users and the one or more content items.

A twenty-fifth aspect combinable with any of the previous aspects further includes displaying the relevance indicator for a particular content item displayed on the virtual workspace.

In a twenty-sixth aspect combinable with any of the previous aspects, the relevance indicator includes at least one of a graphical or numerical indicator.

A twenty-seventh aspect combinable with any of the previous aspects further includes determining a context menu for a particular content item based, at least in part, on the match of the user context data and the metadata attributes of the particular content item.

A twenty-eighth aspect combinable with any of the previous aspects further includes displaying, in response to a request by the user, the context menu for the particular content item displayed on the virtual workspace.

In a twenty-ninth aspect combinable with any of the previous aspects, the context menu includes an indication to the user of the match of the user context data and the metadata attributes of the particular content item.

Various embodiments of an enterprise portal workspace according to the present disclosure may have one or more of the following features. For example, the enterprise portal workspace may automatically gather user context by connection to various data sources, thereby mitigating the complexity of users and their content requirements (e.g., user's job title, social networks, usage patterns, events). Further, the enterprise portal workspace may generate and/or manage a content data structure in a single semantic network of inter-related content item. The structure may include nodes that include content item meta-data and contextual attributes and edges connecting the nodes that can include one or more sematic scores. As another example, the enterprise portal workspace may facilitate or execute real-time calculation of relevant content items from the semantic network. In some aspects, relevancy may be determined by a contextual query on the network. As another example, the enterprise portal workspace may determine contextual attributes based on the automatic user context gathering at that moment (e.g., in real time and also including past user context). As yet another example, the enterprise portal workspace may filter content items using the contextual attributes. For example, every access to a content item may generate a recording of the context in which it was accessed (e.g., a “debriefing” mechanism). As another example, the enterprise portal workspace may reorganize a user's workspace in order to more quickly and automatically provide relevant content through the workspace. Further, the enterprise portal workspace may expose “big data” content that is typically hidden from user's due to its size and complexity. Also, the enterprise portal workspace may provide a richer experience to a user engaged in the workspace.

Various embodiments of an enterprise portal workspace according to the present disclosure may have one or more of the following features. For example, a portal workspace user can determine and fine tune contextual attributes that are used in querying relevant workspace content. Further, user (or group) context can be changed to reflect that of a group (or enterprise) rather than a specific person (or persons). Also, content items may offer real time collaboration between users.

These general and specific aspects may be implemented using a device, system or method, or any combinations of devices, systems, or methods. The details of one or more implementations are set forth in the accompanying drawings and the description below. Other features, objects, and advantages will be apparent from the description and drawings, and from the claims.

### DESCRIPTION OF DRAWINGS

FIG. 1 illustrates an example distributed computing system operable to generate, view, modify, and/or otherwise manipulate an enterprise portal workspace;

FIG. 2 illustrates an example architecture of a virtual distributed computing system operable to generate, view, modify, and/or otherwise manipulate an enterprise portal workspace;

FIGS. 3A-3F illustrate example enterprise portal workspaces having one or more workspace modules; and

FIGS. 4-6 illustrate example methods for using an enterprise portal workspace.

### DETAILED DESCRIPTION

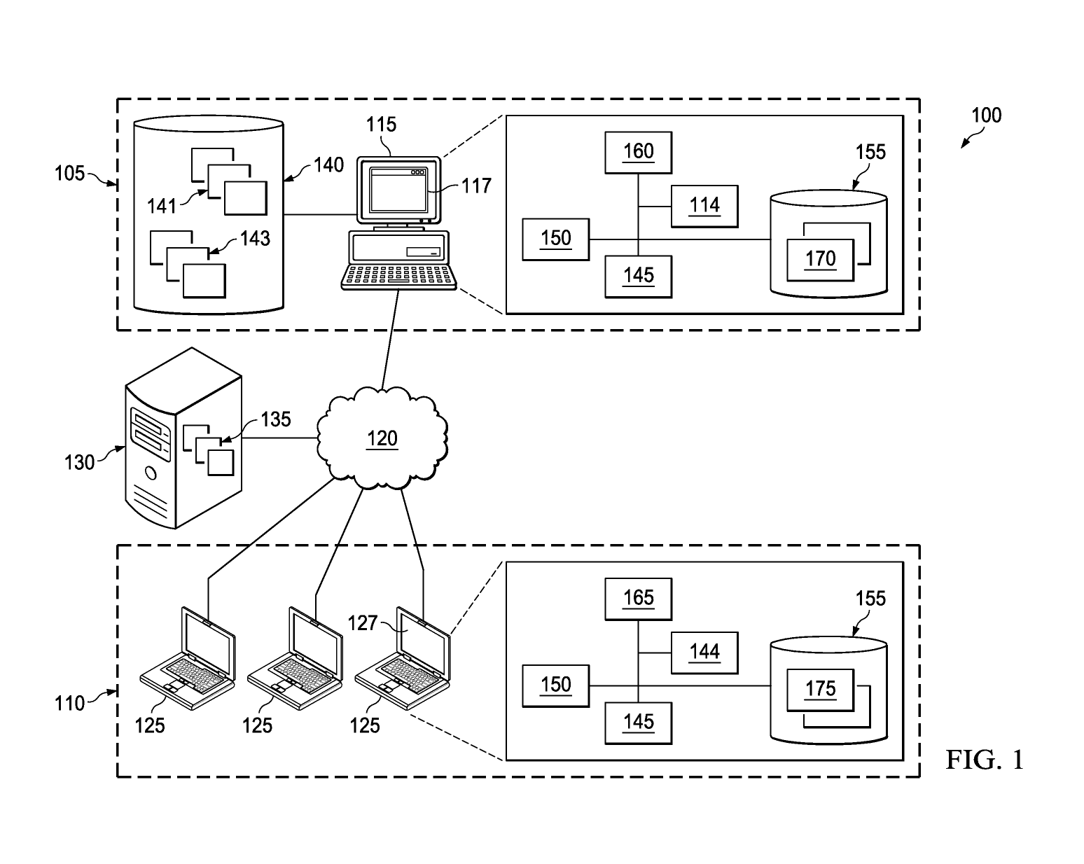

FIG. 1 illustrates an example distributed computing system 100 operable to generate, view, modify, and/or otherwise manipulate an enterprise portal workspace. According to the present disclosure, an enterprise portal workspace may be a virtual workspace viewable (e.g., through a graphical user interface of a particular computing device), modifiable, and or engageable by a user that presents content that is related or associated with user context of the workspace, such as, for example, a user's business context, social context, and other context that may be specific to the user or the user's groups (e.g., business, social, or otherwise). For example, in some aspects, user context data in the enterprise portal workspace is identified and, based on such data, a semantic network that is generated to include metadata of many content items (e.g., business content, social content, web content, multimedia content and other forms of content) is queried to match the user context data with the metadata. One or more content items are identified based on the query and the identified content items are ranked according to the matches and prepared for display through the virtual workspace.

The illustrated computing environment 100 includes an on-demand system 105, an on-premise system 110, and a remote computing system 130 communicably coupled through a network 120. Although illustrated as single systems, each of the systems 105, 110, and 130 may include more than one system and/or more than one computing device (e.g., computer, laptop, server, mobile device, and otherwise) within a distributed computing environment. Further, in some aspects, on-demand system 105 may be an enterprise system (e.g., on-premise). In general, computing environment 100 depicts an example configuration of a system capable of providing stateful execution of stateless applications in a substantially transparent way, as well as dynamically determining the particular application's mode of operation in response to requests from its clients (e.g., client appliances 125).

The illustrated on-demand system 105 includes one or more server appliances 115 having corresponding graphical user interfaces (GUIs) 117. In general, the server appliance 115 is a server that stores one or more applications, where at least a portion of the applications are executed via requests and responses sent to users or clients within and communicably coupled to the illustrated environment 100 of FIG. 1. In some instances, the server appliance 115 may store a plurality of various hosted applications 114, while in other instances, the server appliance 115 may be a dedicated server meant to store and execute only a single hosted application (e.g., the enterprise portal workspace (server) 160). In some instances, the server appliance 115 may comprise a web server, where the applications, such as the enterprise portal workspace (server) 160 represent one or more web-based applications accessed and executed via network 120 by the client appliances 125 of the environment 100 to perform the programmed tasks or operations of the hosted applications 114.

At a high level, the server appliance 115 comprises an electronic computing device operable to receive, transmit, process, store, or manage data and information associated with the environment 100. Specifically, the server appliance 115 illustrated in FIG. 1 is responsible for receiving application requests from one or more applications (e.g., associated with the clients 125 of environment 100 and responding to the received requests by processing said requests in an associated hosted application, and sending the appropriate response from the hosted application back to the requesting client application 144. In addition to requests from the external clients 125 illustrated in FIG. 1, requests associated with the hosted applications 114 may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single server appliance 115, environment 100 can be implemented using two or more server appliances 115, as well as computers other than servers, including a server pool. Indeed, server appliance 115 may be any computer or processing device such as, for example, a blade server, general-purpose personal computer (PC), Macintosh, workstation, UNIX-based workstation, or any other suitable device (e.g., smartphones, PDAs, tablets). In other words, the present disclosure contemplates computers other than general purpose computers, as well as computers without conventional operating systems. Further, illustrated server appliance 115 may be adapted to execute any operating system, including Linux, UNIX, Windows, Mac OS, or any other suitable operating system.

The illustrated server appliance 115 is communicably coupled with in-memory database 140 in the on-demand system 105. In some embodiments, server 115 and/or certain of its components may be integrated with database 140 so that, for instance, processing (e.g., all or partial) may be performed directly on in-memory data with processing results passed (e.g., via a communication channel) directly to a client. In alternative embodiments, the in-memory database 140 may be located external to the on-demand system 105 and communicably coupled to one or more of the on-demand system 105 and/or on-premise system 110 through the network 120. The illustrated in-memory database 140 may include integrated processing, e.g., all business and/or analytic operations done in processing memory. Moreover, content from business content sources and other content sources (described more fully below) may be replicated from one or more transactional systems (e.g., coupled to the network 120) to the in-memory database 140 immediately. Thus, the in-memory database 140, in some aspects, may handle the analytical systems for all business data and other content in real-time, as opposed to, for instance, computational processing systems that have separate transactional and analytical systems that connect through relational databases (e.g., relational databases stored on magnetic memory that require a process, e.g., ETL, to transfer data from one system to another not in real time but with a delay of an hour, day, week, or longer).

In some embodiments, the in-memory database 140 may expose business data and capabilities to improve an end-solution for end users (e.g., the client appliances 125). The in-memory database 140 may reside on top of a computational engine (e.g., in the server appliance 115 or otherwise) that facilitates fast manipulations on large amounts of business data and/or replication of entire business suite information. Thus, in some embodiments, the in-memory database may provide for the following design principles/concepts: business data in real-time (e.g., GUI patterns for constantly updated business data); well modeled tables and data cubes (e.g., in order to provide semantic services); a highly parallelized computational engine (e.g., for computationally intensive GUI patterns such as real time alerts and/or suggestions); close coupling of business logic and business data (e.g., eliminating indexing and caching); and coupling of business and social and multimedia content.

The illustrated in-memory database 140 stores one or more content items 143. The content items 143, generally, include business content, other enterprise content, social content, multimedia content, user-specific content and profiles, and other content, in a variety of forms (e.g., structured data such as data cubes, unstructured data such as documents and files, and semi-structured data such as HTML data). In some aspects, the content items 143 are a part of “big data” that includes a vast amount of information that is associated with a user's real and virtual life and a variety of user context.

For example, the content items 143 may include and/or reference a variety of objects that store and/or include business data. For instance, the content items 143 may be data cubes, such as OLAP (online analytical processing) cubes. The data cubes may consist of a data structure that allows for columnar data storage rather than, e.g., row data storage; different types of indices compared to relational databases; and in-memory technology as compared to data stored in relational databases. The data cube may also allow manipulation and/or analysis of the data stored in the cube from multiple perspectives, e.g., by dimensions, measures, and/or elements of the cube. A cube dimension defines a category of data stored in the cube, for example, a time duration of certain business data, a product or service, business user roles, and a variety of other categories. In other words, a cube dimension may be one way to slice business data stored in the cube according to some business logic (e.g., logic within and/or associated with the enterprise portal workspace modules). In some instances, the data cube may have three-dimensions, but any number of dimensions may be designed into the cube (e.g., a hypercube).

A cube measure may be a fact, such as a numeric fact, that is categorized into one or more dimensions. Measures may include, for example, specific product sales data according to a set period of time. Measures may also include, for example, manufacturing efficiency data for a particular organizational unit of a business enterprise. In short, measures may include any appropriate business data that may be manipulated according to business logic to assist or support the business enterprise.

One or more functions may be performed on a data cube. For instance, the data cube may be pivoted, in various ways. Each pivot provides the business user with a distinct view of particular business data stored in the cube. For instance, in one view, a business user may be presented with sales data of a specific data within a particular geographic region across a particular time period with a particular focus on the sales vs. geography relationship. In another view, the same data (e.g., the same measures and elements) may be presented with a different focus, e.g., the sales vs. time period relationship. In some aspects, pivoting a data cube in real-time may allow the business user to more efficiently analyze the business data.

Other functions performable on data cubes may be, for instance, slice, dice, drill down/up, and roll-up. A slice operation identifies a subset of a multi-dimensional array corresponding to a single value for one or more members of the cube dimensions not in the subset. A dice operation is a slice operation on more than two dimensions of a data cube (or more than two consecutive slices). A drill down/up operation allows the business user to navigate the data cube's levels of data to reveal levels containing the most summarized (up) data to the most detailed (down) data. A roll-up operation involves computing all of the data relationships for one or more dimensions of the data cube.

The content items 143 may include and/or store other forms of data along with or in place of data cubes. For example, the content items 143 may represent, store, and/or reference data from one or more content sources, such as web content, feeds, REST services, business data repositories, reports, status updates, discussions, wikis, blogs, and other content sources. Of course, while illustrated as contained in the in-memory database 140, the content items 143 may also be stored, for example, in one or both of the memories 155, in the remote computing system 130, and/or a separate repository communicably coupled to the network 120. In some embodiments, the content items 143 may be stored in a raw, compiled, or compressed form or combination thereof.

The content items 143 include metadata that, in some aspects, may be parsed and stored and/or used to generate one or more semantic networks 141 that are stored in the in-memory database 140. For example, in some aspects, such as with respect to structured data, each content item 143 may have a consistent schema with metadata attributes, while, with respect to unstructured data, for example, one or more basic metadata properties (e.g., outside of a constant schema) may be parsed and stored (e.g., to generate the semantic network 141). The semantic network 141, in some aspects, may include multiple (e.g., hundreds, thousands, or more) of nodes that store the parsed metadata and edges that connect the nodes. In some aspects, the edges of the semantic network 141 may include and/or represent sematic scores that define relationships between nodes (e.g., a contextual similarity between nodes). Thus, in some aspects, the semantic network may generally comprise nodes of metadata (e.g., contextual attributes of content items) and edges that connect the nodes and that define semantic relationships between nodes.

The illustrated on-premise system 110 includes one or more client appliances 125 having corresponding GUIs 127. Each client appliance 125 may be any computing device operable to connect to or communicate with at least the on-demand system 105 and/or via the network 120 using a wireline or wireless connection. Further, as illustrated, each client appliance 125 includes a processor 150, an interface 145, and a memory 155. In general, each client appliance 125 comprises an electronic computer device operable to receive, transmit, process, and store any appropriate data associated with the environment 100 of FIG. 1. It will be understood that there may be any number of client appliances 125 associated with, or external to, environment 100. For example, while illustrated environment 100 illustrates three client appliances, alternative implementations of environment 100 may include a single client appliance 125 communicably coupled to the on-demand system 105, or any other number suitable to the purposes of the environment 100.

Additionally, there may also be one or more additional client appliances 125 external to the illustrated portion of environment 100 that are capable of interacting with the environment 100 via the network 120. Further, the term “client” and “user” may be used interchangeably as appropriate without departing from the scope of this disclosure. Moreover, while each client appliance 125 is described in terms of being used by a single user, this disclosure contemplates that many users may use one computer, or that one user may use multiple computers. As used in this disclosure, client appliance 125 is intended to encompass a tablet computing device, personal computer, touch screen terminal, workstation, network computer, kiosk, wireless data port, smart phone, personal data assistant (PDA), one or more processors within these or other devices, or any other suitable processing device. For example, each client appliance 125 may comprise a computer that includes an input device, such as a keypad, touch screen, mouse, or other device that can accept user information, and an output device that conveys information associated with the operation of the on-demand system 105 or the client appliance 125 itself, including digital data, visual information, any application, or the GUI 127. Both the input and output device may include fixed or removable storage media such as a magnetic storage media, CD-ROM, or other suitable media to both receive input from and provide output to users of the client appliances 125 through the display, namely, the GUI 127.

The illustrated network 120 facilitates wireless or wireline communications between the components of the environment 100 (e.g., between the on-demand system 105 and the on-premise system 110), as well as with any other local or remote computer (e.g., remote computing system 130), such as additional clients, servers, or other devices communicably coupled to network 120 but not illustrated in FIG. 1. The network 120 is illustrated as a single network in FIG. 1, but may be a continuous or discontinuous network without departing from the scope of this disclosure, so long as at least a portion of the network 120 may facilitate communications between senders and recipients. The network 120 may be all or a portion of an enterprise or secured network, while in another instance at least a portion of the network 120 may represent a connection to the Internet. In some instances, a portion of the network 120 may be a virtual private network (VPN), such as, for example, the connection between the on-premise system 110 and the on-demand system 105.

Further, all or a portion of the network 120 can comprise either a wireline or wireless link. Example wireless links may include 802.11 a/b/g/n, 802.20, WiMax, and/or any other appropriate wireless link. In other words, the network 120 encompasses any internal or external network, networks, sub-network, or combination thereof operable to facilitate communications between various computing components inside and outside the illustrated environment 100. The network 120 may communicate, for example, Internet Protocol (IP) packets, Frame Relay frames, Asynchronous Transfer Mode (ATM) cells, voice, video, data, and other suitable information between network addresses. The network 120 may also include one or more local area networks (LANs), radio access networks (RANs), metropolitan area networks (MANs), wide area networks (WANs), cellular networks, all or a portion of the Internet, and/or any other communication system or systems at one or more locations.

The illustrated remote computing system 130 is communicably coupled to one or both of the on-demand system 105 and on-premise system 110 through the network 120. In some instances, as illustrated, the remote computing system 130 stores and/or references third party content 135, such as, for example, data objects, web content, electronic communications, content feeds, and other data sources. Although illustrated as a single appliance, the remote computing system 130 may include any number of appliances (e.g., servers, clients, mobile devices, and otherwise) coupled to the network 120 individually and/or in groups. For instance, in some embodiments, the remote computing system 130 may be a web content server delivering web content to one or more of the client appliances 125 in response to a request. In some embodiments, the remote computing system 130 may be a repository storing one or more data objects, such as data cubes or other form of database storing business data.

The illustrated communication interfaces 145 (shown as part of the server appliance 115 and the client appliance 125) facilitate communication among appliances in, for example, the on-premise system 110, the remote computing system 130, and the on-demand system 105. The interfaces 145 may also facilitate communication among the illustrated systems and other systems in a client-server or other distributed environment (including within environment 100) connected to the network. Generally, the interfaces 145 include logic encoded in software and/or hardware in a suitable combination and operable to communicate with the network 120. More specifically, the interfaces 145 may include software supporting one or more communication protocols associated with communications such that the network 120 or interface's hardware is operable to communicate physical signals within and outside of the illustrated environment 100.

The illustrated processors 150 (shown as part of the server appliance 115 and the client appliance 125) may be a central processing unit (CPU), a blade, an application specific integrated circuit (ASIC), a field-programmable gate array (FPGA), or another suitable component. Generally, the processors 150 execute instructions and manipulate data to perform the operations of the respective server appliance 115 and client appliance 125 and, specifically, the enterprise portal workspace module (server) 160 and enterprise portal workspace module (client) 165), as well as any other applications. Specifically, the server appliance's processor 150 executes the functionality required to receive and respond to requests from the client appliances 125 and their respective applications (e.g., enterprise portal workspace (client) 165), as well as the functionality required to perform the other operations of the enterprise portal workspace module (server) 160.

Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate. Although illustrated as a single processor 150 for each of the respective server appliance 115 and client appliance 125 in FIG. 1, two or more processors may be used according to particular needs, desires, or particular embodiments of environment 100.

The illustrated memories 155 (shown as part of the server appliance 115 and the client appliance 125) may include any memory or database module and may take the form of volatile or non-volatile memory including, without limitation, magnetic media, optical media, random access memory (RAM), read-only memory (ROM), removable media, or any other suitable local or remote memory component. Each memory 155 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the respective server appliance 115 and client appliance 125. Additionally, each memory 155 may include any other appropriate data, such as VPN applications, firmware logs and policies, firewall policies, a security or access log, print or other reporting files, as well as others.

As illustrated, memory 155 of the server appliance 115 includes and/or stores one or more server content items 170. Memory 155 of the client appliance 125 includes and/or stores one or more client content items 175. In some embodiments, the server content items 170 and/or the client content items 175 may be similar to the content items 143 stored in the in-memory database 140. For example, the content items 170 and 175 may be data cubes, tables, reports, or other content sources, such as web content, electronic communications, feeds, and otherwise. Regardless of the form of the content items 170 and 175, these objects may contain and/or reference business or other data (e.g., social, multimedia, and otherwise) on which logic may be applied, e.g., by the enterprise portal workspace module (server) 160 and/or enterprise portal workspace module (client) 165, in order to realize and/or accomplish a task in a business environment.

The illustrated computing system 100 includes an enterprise portal workspace module (server) 160 and an enterprise portal workspace module (client) 165. At a high level, each of the enterprise portal workspace module (server) 160 and an enterprise portal workspace module (client) 165 (referred to collectively as the enterprise portal workspace modules) is any application, program, module, process, or other software that may execute, change, delete, generate, or otherwise manage information according to the present disclosure, particularly in response to and in connection with one or more requests received from the illustrated client appliances 125 and their associated applications. In certain cases, only one enterprise portal workspace module (server) 160 may be located at a particular server appliance 115. In others, a plurality of related and/or unrelated enterprise portal workspace module (server) 160 may be stored at a single server appliance 115, or located across a plurality of other server appliances 115 in the on-demand system 105, as well.

In certain cases, the enterprise portal workspace modules may be implemented as composite applications. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, the enterprise portal workspace modules may represent web-based applications accessed and executed by remote client appliances 125 or client applications 144 via the network 120 (e.g., through the Internet).

Further, while illustrated as internal to server appliance 115, one or more processes associated with the enterprise portal workspace module (server) 160 may be stored, referenced, or executed remotely. For example, a portion of the enterprise portal workspace module (server) 160 may be a web service associated with the application that is remotely called, while another portion of the enterprise portal workspace module (server) 160 may be an interface object or agent bundled for processing at a remote client appliance 125 via the enterprise portal workspace module (client) 165. Moreover, any or all of the enterprise portal workspace modules may be a child or sub-module of another software module or enterprise application (not illustrated) without departing from the scope of this disclosure.

The enterprise portal workspace, or enterprise portal, is also known as an enterprise information portal (EIP) or a corporate portal, and is a framework for integrating information, people and processes across organizational boundaries. The enterprise portal provides a secure unified access point, often in the form of a web-based user interface, and is designed to aggregate and personalize information through application-specific portals. The enterprise portal is the de-centralized content contribution and content management, which keeps the information always updated. With only a Web browser, users can begin work once they have been authenticated in the portal which offers a single point of access to information, enterprise applications, and services both inside and outside an organization. Portals may present information from diverse sources in a unified way, and provide additional services, such as an internal search engine, e-mail, news, and various other features. Portals are often used by enterprises for providing their employees, customers, and possibly additional users with a consistent look and feel, and access control and procedures for multiple applications, which otherwise would have been separate entities altogether.

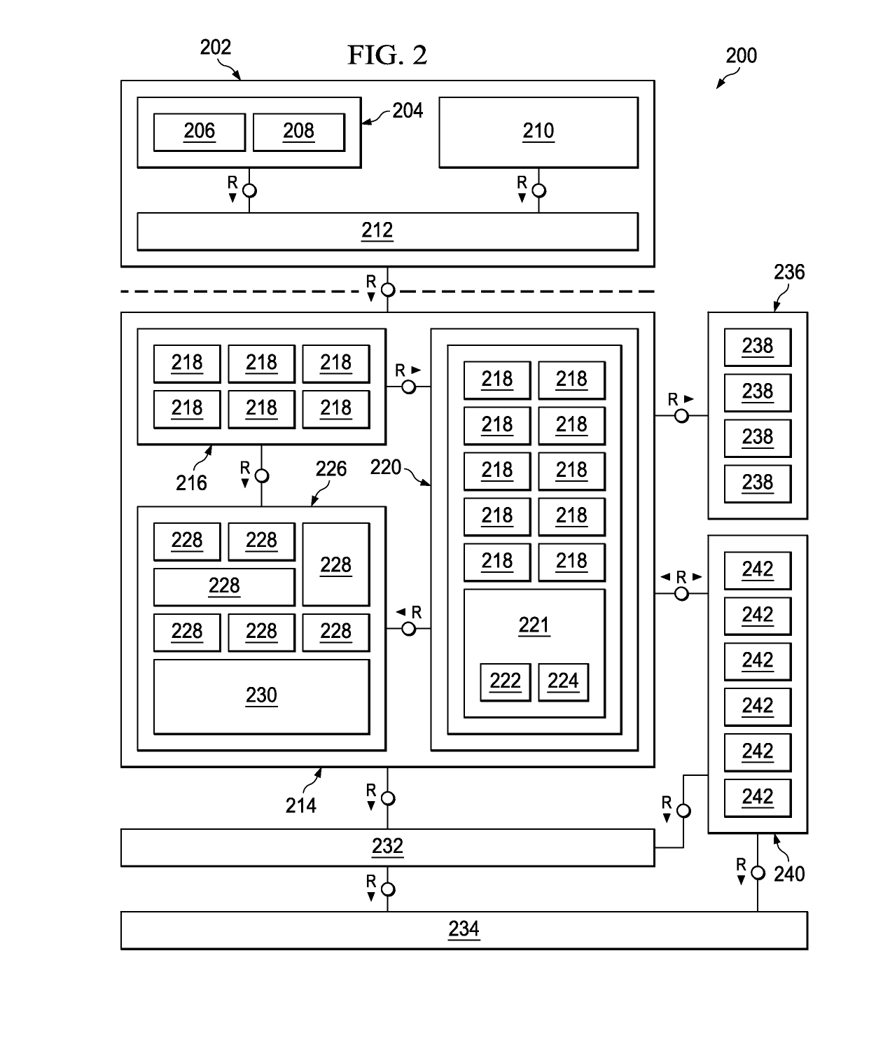

FIG. 2 illustrates an example architecture 200 of a virtual distributed computing system operable to generate, view, modify, and/or otherwise manipulate an enterprise portal workspace. At a high level, the architecture 200 is an example representation of all or portions of the system 100 described in FIG. 1. As illustrated, the architecture 200 includes a portal client 202 communicably coupled to a portal server 214, which in turn is communicably coupled to in-memory modeled data 232, which in turn is communicably coupled to in-memory data 234 (e.g., raw data or big data). The portal server 214 is also communicably coupled to an external application module 236 and an internal application module 240. As illustrated, the internal application module 240 is also communicably coupled to the in-memory modeled data 232 and the in-memory data 234.

The illustrated portal client 202 (e.g., enterprise portal workspace module (client) 165) may be exposed to a user at an appliance, such as one of the client 125 shown in FIG. 1. The portal client 202 includes a UI component 204, a client component model 210, and a connection layer 212. In some aspects, functionality implemented in the portal server 214 may be exposed as services and APIs that can be consumed by portal client(s) 202 that adhere to such APIs

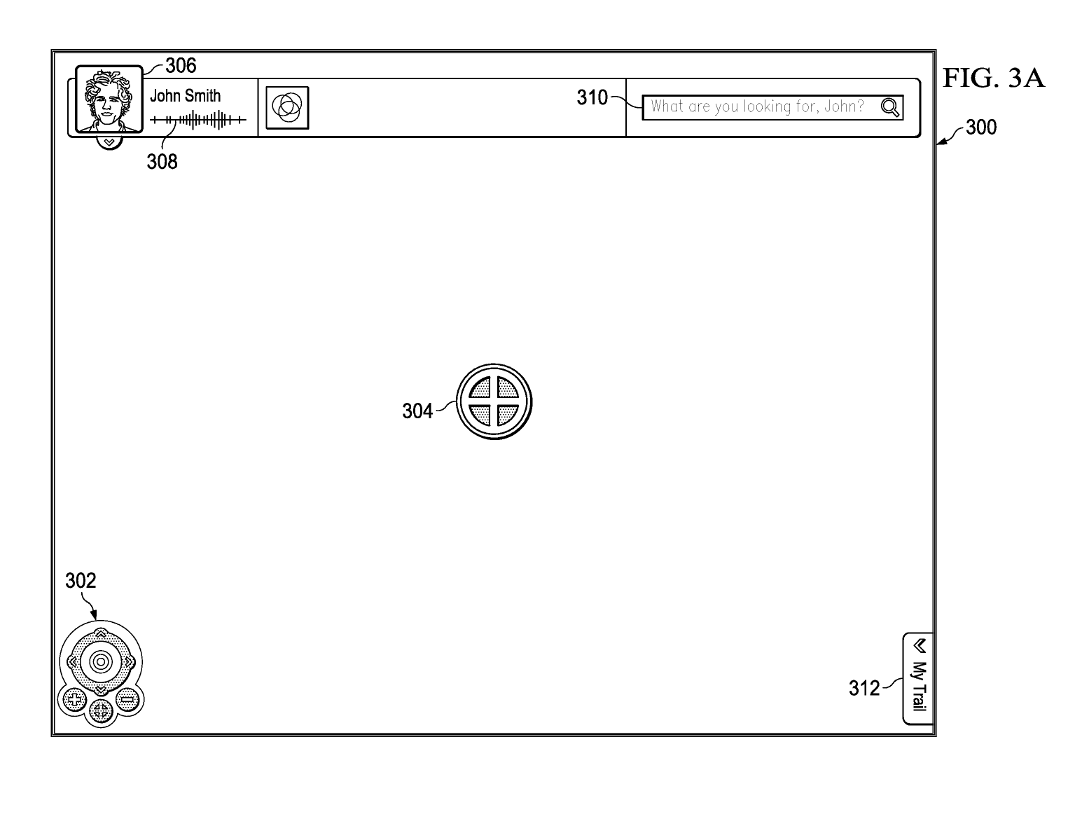

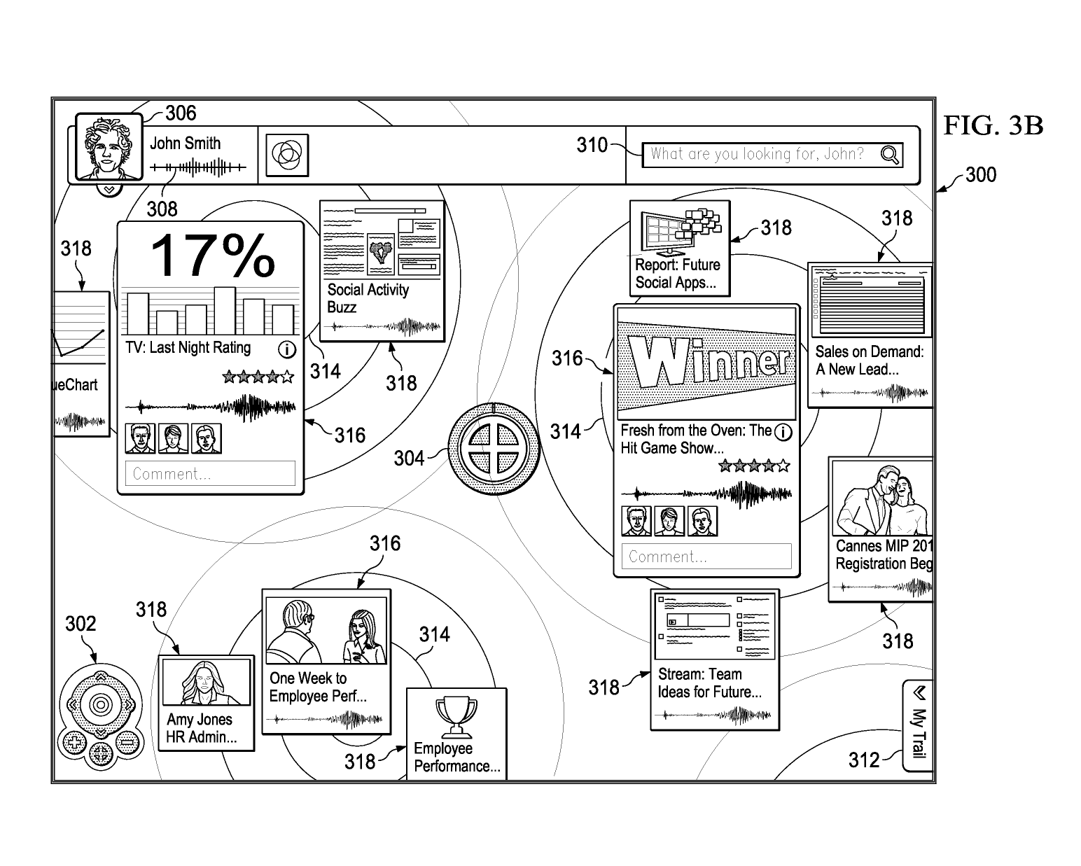

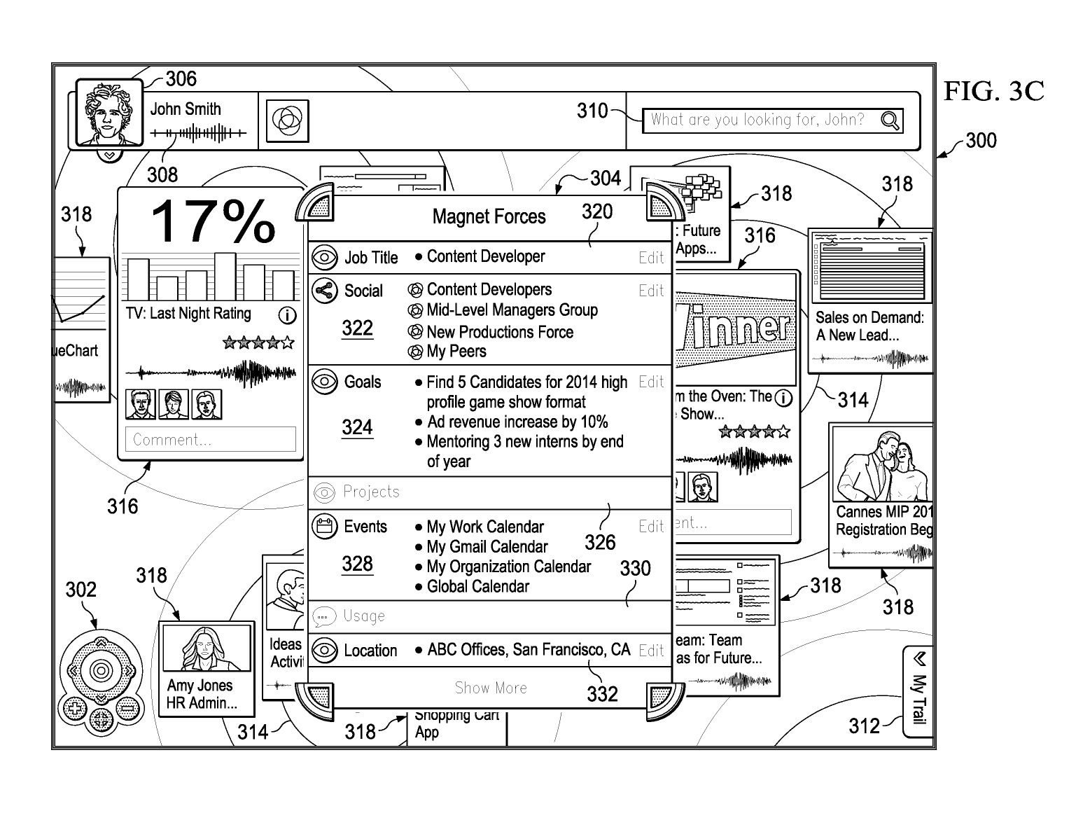

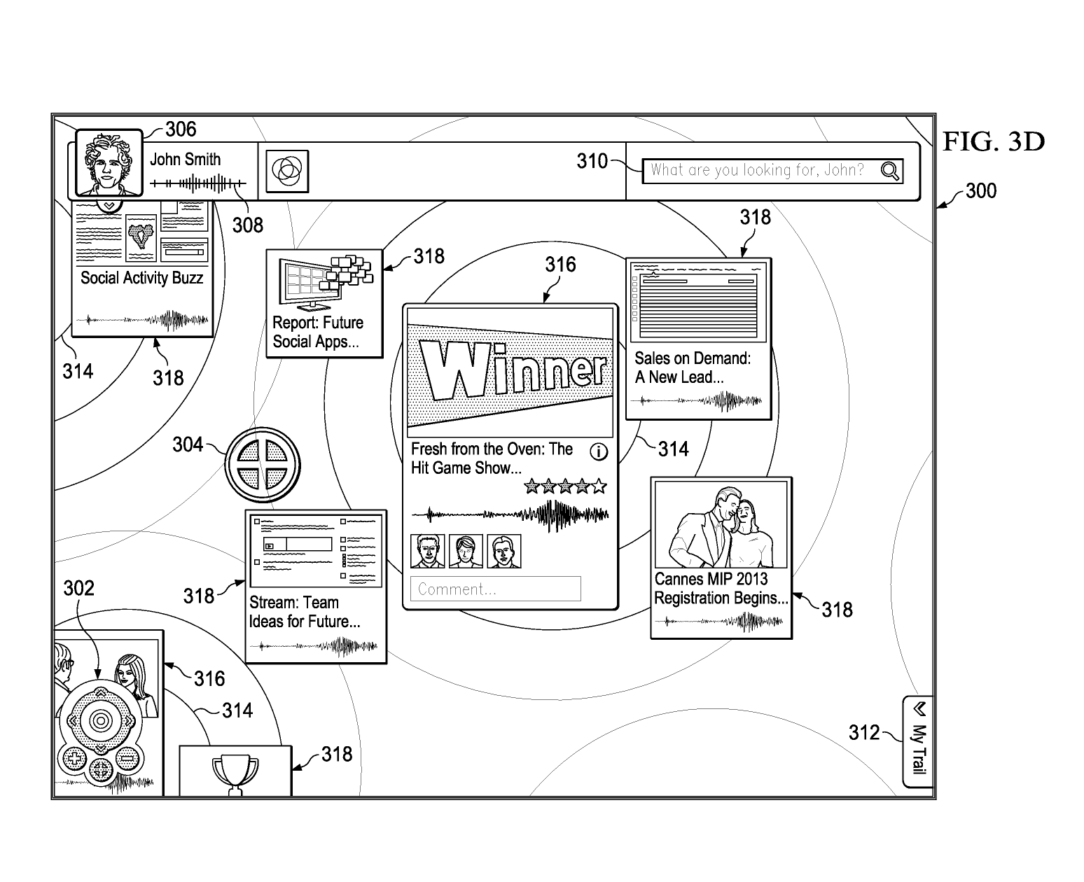

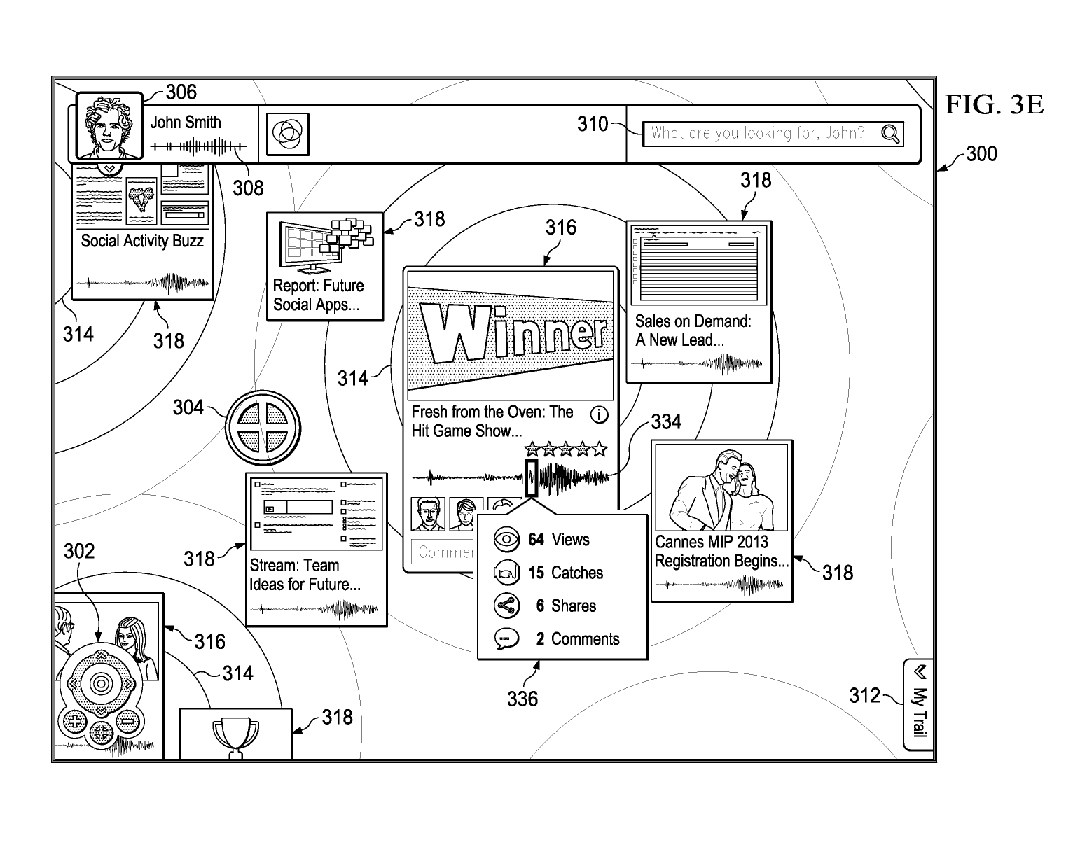

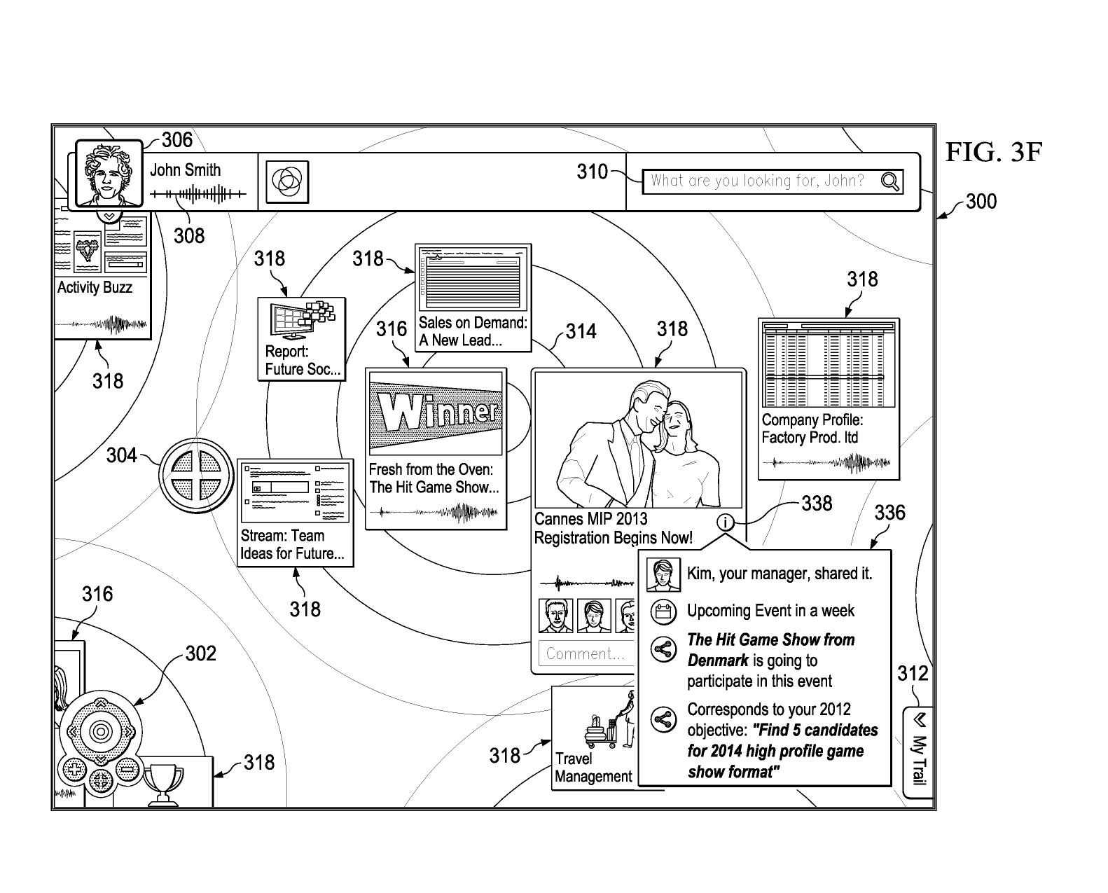

The UI component 204, generally, facilitates and/or generates a graphical user interface displayable to a user on the client appliance (e.g., client 125). To that end, the UI component 204 includes a layout component 206 and a visualization component 208. Together, the layout component 206 and/or the visualization component 208 generate, for example, the visual modules that represent data of the content items 143, as well as, for example, other UI tools (e.g., search boxes, graphics, and otherwise). In addition, and as explained with reference to FIGS. 3A-3E, the layout component 206 and/or the visualization component 208 may generate a context “magnet” (e.g., a contextual menu of user generated context) that determines one or more content items 143 that are presented to the user.

The client component model 210, generally, enables standard representation of content that is displayable through the portal client 202. In addition, the client component model 210 may offer standard methods to manipulate such content.

The connection layer 212 facilitates connectivity between the portal client 202 and the portal server 214, which, together, may combine to provide a complete enterprise portal workspace to a user. Generally, the connection layer 212 may provide, for instance, a single framework for connectivity using various communication protocols. Such protocols include, for example, Hypertext Transfer Protocol (HTTP), HTTPS (extension of HTTP running under the Secure Socket Layer (SSL)), Simple Mail Transfer Protocol (SMTP), Simple Object Access Protocol (SOAP), and Fast Common Gateway Interface (FastCGI), as well as other protocols.

The portal server 214 includes a context module 216, a context and semantic network provider module 220, and a semantic network module 226. Generally, the portal server 214 (along with, in some aspects, the portal client 202) facilitate and includes logic that executes processes (e.g., processes 400, 500, and 600) to provide content to a user that is related or associated with the user context of the workspace, such as, for example, a user's business context, social context, and other context that may be specific to the user or the user's groups (e.g., business, social, or otherwise).

In some aspects, the portal server 214 analyzes content, such as modeled content (e.g., views of data cubes stored in an in-memory database, business intelligence content, and otherwise), build relations between such content, and feeds the semantic network. For example, in some aspects, unstructured content may be structured and then fed to the semantic network. External data sources (e.g., outside of an in-memory database) may be handled in several different ways. The portal server 214 may fetch external data from external sources during runtime, then convert such data to be merged with into the semantic network module 226 in the scope of a user session. Alternatively, the portal server 214 may, for important and frequently used external data providers, model and crawl such data sources into an in-memory graph-store (e.g., for enterprise data sources due to security and legal reasons).

The context module 216, generally, provides and/or manages one or more context sources 218 that define user context, such as a user's business context, social context, and other context that may be specific to the user or the user's groups (e.g., business, social, or otherwise). For instance, context sources 218 may include a user profile (e.g., name, address, user role in an enterprise, and otherwise), a user's social and business circles (e.g., friends, colleagues, managers, employees, and otherwise), a user's goals (e.g., business goals and tasks), a user's projects (e.g., enterprise projects and teams, social projects, and otherwise), a user's business and social events, and a user's interests (e.g., as shown in content items 143 that are viewed, used, interacted with and otherwise). More simply, user context refers to any aspect of data, be it business, social, or otherwise, associated with the user at an instant of time or even over a period of time.

The context and semantic network provider module 220 also includes context sources 218, which provide context data associated with a user. For example, in addition to the example context sources 218 listed above, other context sources 218 may be includes, such as, for instance, a user's calendars (e.g., business and social calendars that include events the user may attend).

The context and semantic network provider module 220 also includes an in-memory modeled content extractor 221, which includes business intelligence content 222 and modeled views 224. The business intelligence content 222 includes, for example, Data cubes persisted in the in-memory data base 140. Modeled views 224 includes, for example, business objects persisted in the in-memory data base 140.

The semantic network module 226 may generate and/or manage a semantic network (e.g., semantic network 141) to enable queries for content based on user context (e.g., people, goals, project, events, and otherwise). The semantic network module 226 may also enrich the semantic network with internal application data like people, unstructured content, modeled in-memory content (e.g., in an offline mode), enrich the network with external application data like exchange, enterprise social business applications, and otherwise (e.g., in an online mode), and execute semantic network analysis operations to search and discover for information in an instant, or real-time, manner.

The semantic network module 226 includes one or more semantic network content 228, such as, for example, people (e.g., a user's social and business contacts), unstructured content (e.g., documents, files, and other content that has not been modeled and/or does not have a constant schema), modeled content (e.g., business data and other data that has been well modeled), calendar events, social media (e.g., webpages, forums, chats, and otherwise), and other content such as email messages. The semantic network module 226 also includes a semantic network store 230, which, in some aspects, may persist and store portions of the semantic network (e.g., semantic network 141). For example, the nodes and edges of the semantic network may be stored in the semantic network store 230.

In some aspects, the context and semantic network provider module 220 extracts metadata of the context sources 218. The context module 216 may enrich the content metadata with contextual attributes, that are then passed to the semantic graph 226. This input is processed and eventually passed to the core graphic store 230 that maintains the semantic network.

The illustrated architecture 200 also includes the in-memory modeled data 232, which in turn is communicably coupled to in-memory data 234 (e.g., raw data or “big data”). For example, the in-memory modeled data 232 may include modeled business intelligence content, modeled unstructured content, and other modeled content that is pulled from the in-memory data 234 as raw data. For instance, the modeled content may be application data with a common semantic model that describes underlying data type and metadata as well as action that can be executed on this data.

The architecture 200 also includes the external application module 236 and the internal application module 240 that are communicably coupled to one or more of the portal server 214, the in-memory modeled data 232, and/or the in-memory data 234. The external application module 236 includes or links one or more external applications 238 for data content. Such external applications 238 include, for example, web calendars, enterprise social business applications, application stores, and otherwise. The internal application module 240 includes or links one or more internal applications 242 (e.g., applications internal to an on-demand computing environment that includes the portal server 214). Such internal applications 242 include, for instance, enterprise resource planning (ERP) applications, business object applications (e.g., performance management, planning, reporting, query and analysis and enterprise information management), and other business enterprise applications. Internal applications 242 (or external applications 238) may also include social network applications and data.

FIGS. 3A-3F illustrate example enterprise portal workspaces having one or more workspace modules that show data content driven by user context. Turning first to FIG. 3A, an example virtual workspace 300 is illustrated as a user 306 opens the workspace 300. The workspace 300 includes several UI components, such as, for example, a navigation tool 302, a search bar 310, and a historical trail 312. Generally, the navigation tool 302 allows the user to scroll and/or move through the workspace 300 to view and/or interact with different content. The search bar 310 allows the user to search for particular content that is already viewable on the workspace 300 or content that may be available to the workspace 300.

The workspace 300 also includes a context magnet 304 that, as illustrated in FIG. 3C, may expand to display the user context that is set and adjustable in the workspace. The user context, in some aspects, may be used to “attract” content to the workspace 300 as the user 306 interacts with the workspace 300. As the user 306 adjusts, adds, removes, and otherwise manages the context through or with the context magnet 304, more or less or different content may be automatically presented to the user 306 through the workspace 300.

The illustrated workspace 300 also includes a user relevance indicator 308. The user relevance indicator 308, generally, may show to the user 306 how much his/her activity in the workspace 300 is registering (e.g., showing relevance) within, for example, his/her enterprise (e.g., business circles), his/her social networks, or otherwise. For example, as content that the user 306 interacts with (e.g., shares, suggests, views, and otherwise) is also interacted with by other users, the user relevance indicator 308 may show increased relevance (e.g., with longer vertical lines like an electroencephalography (EEG) graph).

Turning now to FIG. 3B, the workspace 300 is shown with content being displayed at locations relative to the context magnet 304 and with relatively-sized views. For example, as shown, there are three relevance areas 314 delineated by circular contours in the workspace 300. At or near a center contour of each relevance area 314 is a primary content view 316. As explained more fully below, each primary content view 316 may display relevant content based on user context, for example, as defined by the context magnet 304. In some aspects, the relative distance that the primary content view 316 is from the context magnet 304 may indicate a relevance of the content in the view 316 with user context of the context magnet 304. Further, in some aspects, the relative size of the primary content view 316 may indicate a relevance of the primary content view 316 as compared to other primary content views 316.

FIG. 3B also illustrates multiple secondary content views 318 that are positioned adjacent the primary content views 316. In some aspects, secondary content views 318 may display content that is semantically-related (e.g., shares one or more metadata matches or similarity). Thus, in some aspects, secondary content views 318 may not be semantically-related to user context in the context magnet 304 but may be indirectly semantically-related to such user context by being directly semantically-related to content displayed in primary content views 316. In some aspects, a relative distance from primary content views 316 and/or size of the secondary content views 318 may indicate a relevance and/or a degree of semantic similarity with the primary content views 316.

Turning now to FIG. 3C, the context magnet 304 is shown in an expanded view, which exposes the user context for viewing and/or management. Although a particular interface is shown as representing the context magnet 304, other interfaces (e.g., menus, selection wheels, and otherwise) are contemplated by the present disclosure. As illustrated, the context magnet 304 displays several types of user context and examples of user context data. For example, the context magnet 304 includes profile context 320, which includes, for example, a user's role (e.g., job title) within a business enterprise. Other examples of profile context 320 could be a user's position or office within a non-business enterprise (e.g., charitable group, board, or other group). The context magnet 304 also includes social context 322. The illustrated examples of social context 322 may include one or more groups, organizations, social circles, enterprise circles, or other groups to which the user 306 belongs. The context magnet 304 also includes enterprise context 324, which, as illustrated, includes enterprise goals (e.g., personal goals, team goals, entity goals, and otherwise) that the user 306 may have. The context magnet 304 also includes project context 326 (e.g., business or social projects to which the user 306 belongs) and usage context 330 (e.g., user context gathered based on the user's interactions with content in the workspace 300).

As further illustrated in the example context magnet 304, user context includes event context 328. The event context 328 includes, for example, the user's calendars (e.g., business, social, and otherwise) and can also include non-calendar events. The context magnet 304 also includes location context 332. Location context 332, in some aspects, may include a physical or postal address that is set by the user 306. In some aspects, the location context 332 may be set, for example, by geolocation as determined by global positioning (GPS).

Turning to FIG. 3D, the example workspace 300 is shown as the user 306 focuses on a particular primary content view 316 located in a particular relevance area 314. The primary content view 316 shown in this figure is surrounded by particular secondary content views 318 that are semantically-related to the primary content view 316. In this example, particular secondary content views 318 may be smaller than other secondary content views 318, or further away from the center of the relevance area 314 as compared to other secondary content views 318. In some aspects, the relative size and location of the secondary content views 318 may be indicative of the semantic relationships between the secondary content views 318 and the primary content views 316 and/or the user context of the context magnet 304 (e.g., as determined by metadata matching).

Turning to FIG. 3E, the example workspace 300 is shown as a relevancy menu 335 is exposed to the user 306 in response to a selection (e.g., click, hover over, or otherwise) of a relevancy indicator 334 shown on the primary content view 316. As illustrated, much like the relevancy indicator 308 which shows a degree of relevancy of the user 306 as described above, the relevancy indicator 335 may indicate how much activity the primary content view 316 is registering (e.g., showing relevance) within, for example, the user's enterprise (e.g., business circles), social networks, on the worldwide web, or otherwise. For example, as illustrated, the relevance indicator 334 comprises an “EEG” view with vertical lines that change length over time to indicate an increased or decreased degree of activity of the primary content view 316.

The relevance menu 335, as shown, indicates the types of relevance of the primary content view 316. For example, as shown, “relevance” of the primary content view 316 may be measured in “views,” “catches,” “shares,” and “comments.”

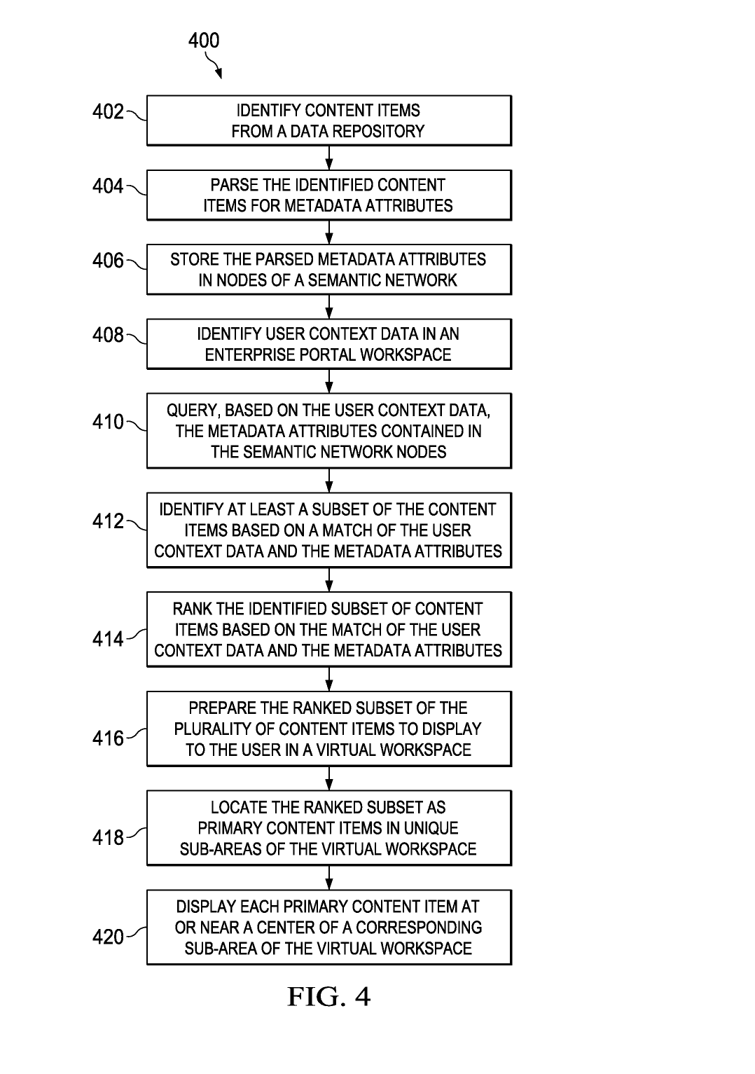

FIGS. 4-6 illustrate example methods for using an enterprise portal workspace. The illustrated methods, for example, may be implemented by all or part of the distributed computing environment 100 and/or the architecture 200, such as, for example, with or through the enterprise portal workspaces 160/165 or portal client/server 202/214. Alternatively, other computing systems or architectures, as appropriate, may implement one or more of the illustrated methods of FIGS. 4-6.

Turning to FIG. 4, method 400 may begin at step 402, when one or more content items (e.g., content items 143) may be identified from a data repository, such as, the in-memory database 140 (or other repository). The identified content items may include, for example, structured data such as data cubes, unstructured data such as documents or other files, and semi-structured data such as HTML data. In step 404, the identified content items are parsed for one or more metadata attributes of each content item. In some aspects, after the identified content items are parsed in step 404, the parsed metadata attributes may be enriched with contextual attributes, which may facilitate later querying of the semantic network (e.g., the nodes) with a contextual query.

The parsed metadata attributes are then stored in step 406, for example, in a semantic network. The semantic network, in some aspects, includes nodes that store and/or reference the parsed metadata and edges between nodes that store and/or reference semantic scores between nodes (e.g., semantic scores that indicate a degree of similarity between nodes).

In step 408, user context data in an enterprise portal workspace is identified. User context data, in some aspects, may include, for example, user profile data, user provided context data, and/or enterprise context data. For example, user context data may include a user's role in a business enterprise, a user's position in a business enterprise, a user's role in a social enterprise, a user's membership of a social group, or a user's location. User context data may also include a user's business goals, a user's business events, or a user's social events. User context data may also include business data, business objects, web content, or social media content.

In step 410, the metadata attributes of the semantic network nodes are queried based on the identified user context data. In step 412, a subset of the content items are identified by the query based on a match of the user context data (or metadata associated with the user context data) and the metadata attributes stored in the semantic network nodes. In step 414, the identified subset of content items are ranked based on the match of user context data (e.g., metadata associated with the context data) and the metadata attributes.

In step 416, the ranked subset of content items are prepared for display to the user in a virtual workspace of the enterprise portal workspace. For example, higher ranked content items (e.g., content items with metadata attributes that more closely match the user context data) may become primary content items.

In step 418, the primary content items are located in unique sub-areas of the virtual workspace (e.g., in unique relevance areas 314). In step 420, each primary content item is displayed in a corresponding unique sub-area of the virtual workspace (e.g., as primary content views 316 in workspace 300). In some implementations, edges of the semantic network (e.g., scores) may be queried after primary content items are identified. The scores may be then used to determine secondary content items to display. In some aspects, secondary content items may be displayed (e.g., as secondary content views 318) in the workspace adjacent the primary content views.

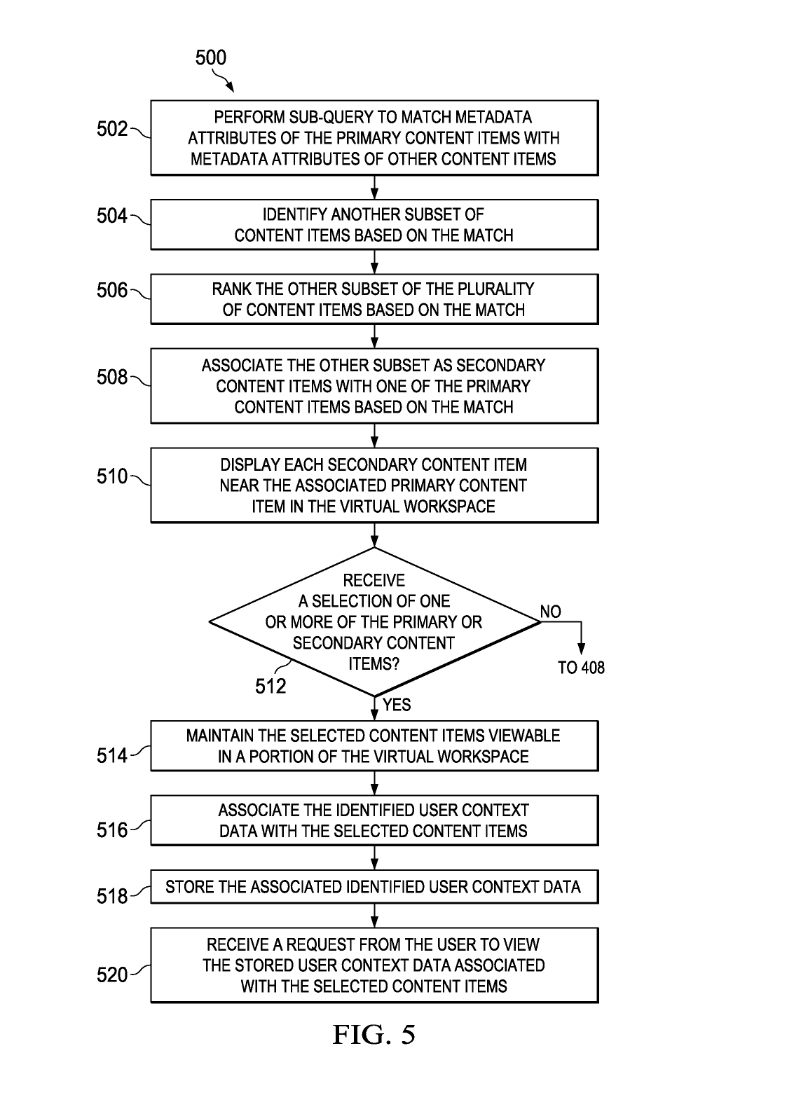

Turning to FIG. 5, method 500 may begin at step 502, which, in some aspects, may be performed subsequent to or simultaneous with one or more steps of method 400. Alternatively, in some aspects, method 500 may begin when the user focuses on any sub-item in the workspace, thereby making the sub-item centered and larger, which may cause subsequent semantically-related items to be displayed around the focused content item. In step 502, a sub-query of the semantic network is performed to match metadata attributes of the primary content items with metadata attributes of other content items (e.g., content items other than those identified as primary content items). For example, in step 502, the available contextual attributes may act as multipliers for the edge scores of the semantic network, causing higher rankings for secondary items that are relevant in the given context.

In step 504, a sub-set of content items is identified based on the match in step 502. In step 506, the identified subset of content items is ranked based on the match (e.g., based on scores defined by edges of the semantic network that describe semantic similarity between nodes).

In step 508, the ranked subset of content items is associated, as secondary content items, with one or more of the primary content items previously identified based on the match. For example, secondary content items may be identified based on a close semantic similarity with the primary content items and/or user context data. In step 510, the secondary content items are displayed in the virtual workspace near (e.g., within the same unique sub-area) the associated primary content item.

In step 512, a decision is made whether a selection is received (e.g., from the user) of one or more of the primary content or secondary content items. If a selection is not made, method 400 may return, for instance, to step 408. If a selection is received, then, in step 514, the selected content item(s) (e.g., primary and/or secondary), or a reference to such content item(s), is maintained in a particular portion of the virtual workspace (e.g., is “pinned” at a particular location). In step 516, the user context data that was previously identified (e.g., at step 408) is associated with the selected content item(s). For example, if a selection was made at a particular time, then the user context displayed and/or active in the context magnet (or other user context menu) may be associated as a “snapshot” of user context when the user selected the particular content item(s).

In step 518, the associated user context data is persisted, for example, on the in-memory database or other repository in the distributed computing system. Subsequently, either immediately afterward or at a later time (e.g., days, months, years), a request may be received from the user to view the stored user context data associated with the selected content item(s). In some aspects, the user may therefore be able to recall his/her context (e.g., role in an enterprise, project being worked on, popular social media) that was current when the content item(s) were saved and maintained.

Method 500 may include one or more additional steps not shown in FIG. 5. For example, users may explicitly enrich content items with attributes such as comments, rating, or share the items with other users. These activities may be stored in the content item metadata and can be displayed as a content item's activity stream that persists, among other information, the action that has been performed, who performed it, and when it was performed.

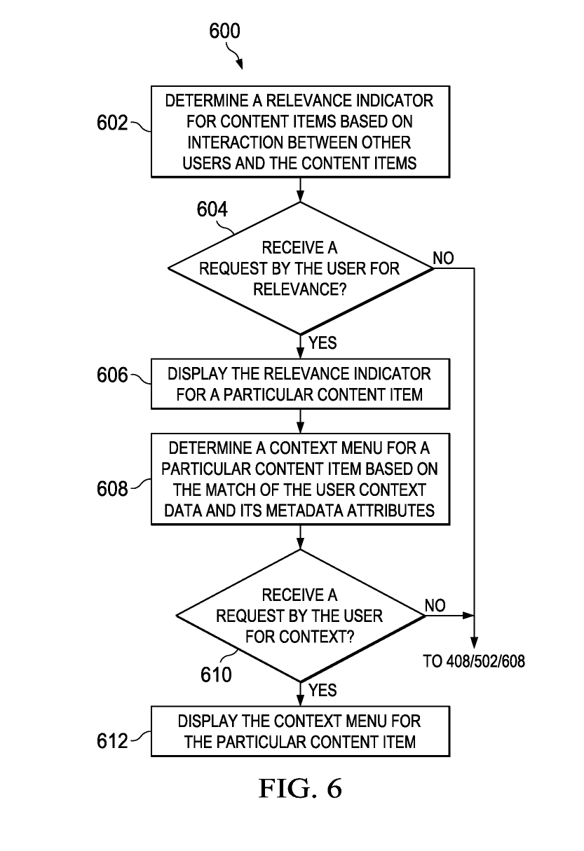

Turning to FIG. 6, method 600 may begin at step 602, which, in some aspects, may occur after one or more content items are presented to the user through the virtual workspace. In step 602, a relevance indicator for a content item may be determined based on, for instance, interaction between all system users (or a subset of system users) and the content item. In some aspects, all users may include users in a particular business enterprise or social group. In some aspects, all users may include all users in the network (e.g., the Internet) regardless of enterprise or group affiliation.

In step 604, a decision is made whether a request is received from a user for the relevance of a particular content item. If no request is received, method 600 may go to step 608, step 408, or step 502, for example. If a request is received, then the relevance indicator (e.g., an “EEG” indicator showing content item relevance) may be displayed to the user in step 606. In some aspects, the relevance of a particular content item may be determined, for example, based on a number of hits, likes, shares, or other actions taken by users with respect to the content item.

In step 608, a context menu (e.g., context menu 335) for a content item may be determined based on, for instance, a match of metadata associated with the content item and the user context (e.g., through a semantic network). In step 610, a decision is made whether a request is received from a user for the context of a particular content item. If no request is received, method 600 may go to step 602, step 408, or step 502, for example. If a request is received, then the context menu (e.g., a pop-up menu or otherwise) may be displayed to the user in step 612. In some aspects, the context of a particular content item (e.g., the basis of the content item's inclusion in the virtual workspace may be determined, for example, based on how closely the metadata of the content item matches the user context data or metadata associated with the user context data.

In some aspects, method 600 may include one or more additional steps not shown in FIG. 6. For instance, new, relevant content items that have been added to the semantic network may be brought to the attention of the user. This may be indicated in the workspace by, for example, a blinking circle. This may provide the ability to reflect real-time changes in available content.

A number of implementations have been described. Nevertheless, it will be understood that various modifications may be made. For example, other methods described herein besides those or in addition to those illustrated in FIGS. 4-6 may be performed. Further, the illustrated steps of methods 400, 500, and/or 600 may be performed in different orders, either concurrently or serially. Further, steps may be performed in addition to those illustrated in method 400, and some steps illustrated in methods 400, 500, and/or 600 may be omitted without deviating from the present disclosure.

As further examples, activity conducted one content items by a user, for example in the virtual workspace, can be saved and displayed in real-time in a content item activity stream. Also, the system may include a real-time notification mechanism that indicates a new relevant content item that, e.g., has been ranked high enough to be included in the workspace or is trending (e.g., relevance is increasing/accelerating) at a high rate. Also, an administrator of the system may publish featured content to targeted users based on, for instance, their current context. Further, in some aspects, group context, rather than or in addition to user context, may be used, e.g., in a context magnet as described. Also, a user (or group representative) may be able to view, change, and/or fine-tune contextual attributes used by the system.

As further examples, a user may switch to a group context that would then determine the context from the view point of the selected group of users. By switching, content items may be re-ranked and displayed content items may change accordingly. Further, content items may be pushed, e.g., by an enterprise or other entity, based on a user's current context. This may enable delivering content in the form of very specific target users. Accordingly, other implementations are within the scope of the following claims.

What is claimed is:

1. A method performed with a computing system for managing an enterprise portal workspace, the method comprising:
identifying user context data in the enterprise portal workspace;
querying, based on the user context data, a semantic network comprising nodes and edges, the nodes comprising metadata attributes of a plurality of content items;
identifying at least a subset of the plurality of content items based on a match of the user context data and the metadata attributes of the plurality of content items;
ranking the identified subset of the plurality of content items based on the match of the user context data and the metadata attributes of the plurality of content items; and
preparing the ranked subset of the plurality of content items to display to the user in a virtual workspace of the enterprise portal workspace.

2. The method of claim 1, further comprising:
identifying the plurality of content items from a data repository;
parsing the identified plurality of content items for the metadata attributes; and
storing the parsed metadata attributes in nodes of the semantic network.

3. The method of claim 2, wherein the data repository comprises an in-memory database that is communicably coupled to an enterprise computing system.

4. The method of claim 1, wherein each content item of the ranked subset comprises a primary content item, the method further comprising:
locating each primary content item in a unique sub-area of the virtual workspace displayed to the user through the enterprise portal workspace; and
displaying each primary content item at or near a center of a corresponding sub-area of the virtual workspace.

5. The method of claim 4, further comprising:
performing a sub-query of the semantic network to match the metadata attributes of the primary content items with metadata attributes of other content items of the plurality of content items;
identifying another subset of the plurality of content items based on the match of metadata attributes of the primary content items with metadata attributes of other content items of the plurality of content items; and
ranking the identified other subset of the plurality of content items based on the match of metadata attributes of the primary content items with metadata attributes of other content items of the plurality of content items.

6. The method of claim 5, wherein each content item of the ranked other subset comprises a secondary content item, the method further comprising:
associating each secondary content item with one of the primary content items based on the match of metadata attributes with the primary content item; and
displaying each secondary content item near the associated primary content item in the virtual workspace.

7. The method of claim 1, further comprising:
receiving, from the user, a selection of one or more of the ranked plurality of content items; and
maintaining the selected content items or a reference to the selected content items viewable in a portion of the virtual workspace.

8. The method of claim 7, further comprising:
associating the identified user context data with the selected content items;
storing the associated identified user context data; and
receiving, subsequent to storing the user context data, a request from the user to view the stored user context data associated with the selected content items.

9. The method of claim 1, wherein the user context data comprises one or more of user profile data, user provided data, or enterprise content.

10. The method of claim 9, wherein the user profile data comprises one or more of a role in a business enterprise, a position in a business enterprise, a role in a social enterprise, a member of a social group, or a user location,
the user provided data comprises one or more of business goals, business events, or social events, and
the enterprise content comprises one or more of business data, business objects, web content, or social media content.

11. The method of claim 1, further comprising:
determining a relevance indicator for one or more content items based, at least in part, on interaction between other users and the one or more content items; and
displaying the relevance indicator for a particular content item displayed on the virtual workspace.

12. The method of claim 11, wherein the relevance indicator comprises at least one of a graphical or numerical indicator.

13. The method of claim 1, further comprising:
determining a context menu for a particular content item based, at least in part, on the match of the user context data and the metadata attributes of the particular content item; and
displaying, in response to a request by the user, the context menu for the particular content item displayed on the virtual workspace.

14. The method of claim 13, wherein the context menu comprises an indication to the user of the match of the user context data and the metadata attributes of the particular content item.

15. A computer storage medium encoded with a computer program, the program comprising instructions that when executed by one or more computers cause the one or more computers to perform operations comprising:
identifying user context data in an enterprise portal workspace;
querying, based on the user context data, a semantic network comprising nodes and edges, the nodes comprising metadata attributes of a plurality of content items;
identifying at least a subset of the plurality of content items based on a match of the user context data and the metadata attributes of the plurality of content items;
ranking the identified subset of the plurality of content items based on the match of the user context data and the metadata attributes of the plurality of content items; and
preparing the ranked subset of the plurality of content items to display to the user in a virtual workspace of the enterprise portal workspace.

16. The computer storage medium of claim 15, wherein the operations further comprise:
identifying the plurality of content items from a data repository;
parsing the identified plurality of content items for the metadata attributes; and
storing the parsed metadata attributes in nodes of the semantic network.

17. The computer storage medium of claim 16, wherein the data repository comprises an in-memory database that is communicably coupled to an enterprise computing system.

18. The computer storage medium of claim 15, wherein each content item of the ranked subset comprises a primary content item, and the operations further comprise:
locating each primary content item in a unique sub-area of the virtual workspace displayed to the user through the enterprise portal workspace; and
displaying each primary content item at or near a center of a corresponding sub-area of the virtual workspace.

19. The computer storage medium of claim 18, wherein the operations further comprise:
performing a sub-query of the semantic network to match the metadata attributes of the primary content items with metadata attributes of other content items of the plurality of content items;
identifying another subset of the plurality of content items based on the match of metadata attributes of the primary content items with metadata attributes of other content items of the plurality of content items; and
ranking the identified other subset of the plurality of content items based on the match of metadata attributes of the primary content items with metadata attributes of other content items of the plurality of content items.

20. The computer storage medium of claim 19, wherein each content item of the ranked other subset comprises a secondary content item, and the operations further comprise:
associating each secondary content item with one of the primary content items based on the match of metadata attributes with the primary content item; and
displaying each secondary content item near the associated primary content item in the virtual workspace.

21. The computer storage medium of claim 15, wherein the operations further comprise:
receiving, from the user, a selection of one or more of the ranked plurality of content items; and
maintaining the selected content items or a reference to the selected content items viewable in a portion of the virtual workspace.

22. The computer storage medium of claim 21, wherein the operations further comprise:
associating the identified user context data with the selected content items;
storing the associated identified user context data; and
receiving, subsequent to storing the user context data, a request from the user to view the stored user context data associated with the selected content items.

23. The computer storage medium of claim 15, wherein the user context data comprises one or more of user profile data, user provided data, or enterprise content.

24. The computer storage medium of claim 23, wherein the user profile data comprises one or more of a role in a business enterprise, a position in a business enterprise, a role in a social enterprise, a member of a social group, or a user location,
the user provided data comprises one or more of business goals, business events, or social events, and
the enterprise content comprises one or more of business data, business objects, web content, or social media content.

25. The computer storage medium of claim 15, wherein the operations further comprise:
determining a relevance indicator for one or more content items based, at least in part, on interaction between other users and the one or more content items; and
displaying the relevance indicator for a particular content item displayed on the virtual workspace.

26. The computer storage medium of claim 25, wherein the relevance indicator comprises at least one of a graphical or numerical indicator.

27. The computer storage medium of claim 15, wherein the operations further comprise:
determining a context menu for a particular content item based, at least in part, on the match of the user context data and the metadata attributes of the particular content item; and
displaying, in response to a request by the user, the context menu for the particular content item displayed on the virtual workspace.

28. The computer storage medium of claim 27, wherein the context menu comprises an indication to the user of the match of the user context data and the metadata attributes of the particular content item.

29. A system of one or more computers configured to perform operations comprising:
identifying user context data in an enterprise portal workspace;
querying, based on the user context data, a semantic network comprising nodes and edges, the nodes comprising metadata attributes of a plurality of content items;
identifying at least a subset of the plurality of content items based on a match of the user context data and the metadata attributes of the plurality of content items;
ranking the identified subset of the plurality of content items based on the match of the user context data and the metadata attributes of the plurality of content items; and
preparing the ranked subset of the plurality of content items to display to the user in a virtual workspace of the enterprise portal workspace.

30. The system of claim 29, wherein the operations further comprise:
identifying the plurality of content items from a data repository;
parsing the identified plurality of content items for the metadata attributes; and
storing the parsed metadata attributes in nodes of the semantic network.

31. The system of claim 30, wherein the data repository comprises an in-memory database that is communicably coupled to an enterprise computing system.

32. The system of claim 29, wherein each content item of the ranked subset comprises a primary content item, and the operations further comprise:
locating each primary content item in a unique sub-area of the virtual workspace displayed to the user through the enterprise portal workspace; and
displaying each primary content item at or near a center of a corresponding sub-area of the virtual workspace.

33. The system of claim 32, wherein the operations further comprise:
performing a sub-query of the semantic network to match the metadata attributes of the primary content items with metadata attributes of other content items of the plurality of content items;
identifying another subset of the plurality of content items based on the match of metadata attributes of the primary content items with metadata attributes of other content items of the plurality of content items; and
ranking the identified other subset of the plurality of content items based on the match of metadata attributes of the primary content items with metadata attributes of other content items of the plurality of content items.

34. The system of claim 33, wherein each content item of the ranked other subset comprises a secondary content item, and the operations further comprise:
associating each secondary content item with one of the primary content items based on the match of metadata attributes with the primary content item; and
displaying each secondary content item near the associated primary content item in the virtual workspace.

35. The system of claim 29, wherein the operations further comprise:
receiving, from the user, a selection of one or more of the ranked plurality of content items; and
maintaining the selected content items or a reference to the selected content items viewable in a portion of the virtual workspace.

36. The system of claim 35, wherein the operations further comprise:
associating the identified user context data with the selected content items;
storing the associated identified user context data; and
receiving, subsequent to storing the user context data, a request from the user to view the stored user context data associated with the selected content items.

37. The system of claim 29, wherein the user context data comprises one or more of user profile data, user provided data, or enterprise content.

38. The system of claim 37, wherein the user profile data comprises one or more of a role in a business enterprise, a position in a business enterprise, a role in a social enterprise, a member of a social group, or a user location,
the user provided data comprises one or more of business goals, business events, or social events, and
the enterprise content comprises one or more of business data, business objects, web content, or social media content.

39. The system of claim 29, wherein the operations further comprise:
determining a relevance indicator for one or more content items based, at least in part, on interaction between other users and the one or more content items; and
displaying the relevance indicator for a particular content item displayed on the virtual workspace.

40. The system of claim 39, wherein the relevance indicator comprises at least one of a graphical or numerical indicator.

41. The system of claim 29, wherein the operations further comprise:
determining a context menu for a particular content item based, at least in part, on the match of the user context data and the metadata attributes of the particular content item; and
displaying, in response to a request by the user, the context menu for the particular content item displayed on the virtual workspace.

42. The system of claim 41, wherein the context menu comprises an indication to the user of the match of the user context data and the metadata attributes of the particular content item.
